(19) United States
(12) Patent Application Publication
(10) Pub. No.: US 2013/0156895 A1
(43) Pub. Date: Jun. 20, 2013

(54) Method for preparing a ground meat product and kit therefor

(71) Applicant: Donald J. Malisani, Cheney, WA (US)

(72) Inventor: Donald J. Malisani, Cheney, WA (US)

(21) Appl. No.: 13/374,149

(22) Filed: Dec. 14, 2011

(51) Int. Cl. A23L 1/317; B65D 85/00; A23L 1/01; A23L 1/318

(52) U.S. Cl. 426/87; 426/389; 426/315; 426/646

(57) ABSTRACT

A method for preparing a ground meat product and a kit therefor is described and which includes the steps of providing and preparing an uncooked ground meat product; depositing the uncooked ground meat product in the internal cavity of a food product forming container; providing a rolling pin, engaging the rolling pin with the food product forming container so as to provide a densely packed ground meat layer having a given height dimension; removing the resulting uncooked ground meat layer from the internal cavity, and cooking the prepared, uncooked ground meat layer in a cooking appliance.

### TECHNICAL FIELD

The present invention relates to a method for preparing a ground meat product, and a kit therefor, and more particularly to a method which provides a convenient means for preparing an uncooked ground meat layer which may be subsequently cooked in one or more cooking appliances, of various designs, in order to provide a prepared, uncooked, ground meat layer, which has given desirable eating characteristics for subsequent consumption by a user thereof.

### BACKGROUND OF THE INVENTION

Preparing meat products for subsequent consumption has been going on for centuries. The preparation of ground meat products for use in such products as sausages, jerky, and various ground meat patties that may be subsequently smoked, grilled or otherwise baked have long been known. Various methodologies and other devices have been employed to prepare ground meat products such as what are mentioned above. For example, U.S. Pat. No. 7,090,881 relates to a method for the continuous production of dried, ground meat reconstituted as a thin slab. This patent describes a methodology which includes multiple steps including chopping up a meat product in a chopper, conveying the mincemeat into a meat pump, and continuously presenting the output of the meat pump in the form of a tube or a continuous flat strip; unwinding a film capable of forming a scaling sheet around the continuous tube or strip of mincemeat; passing the sheathed mincemeat tube or strip in a rolling device for spreading the mincemeat into a strip configuration and in a thin layer, and then compacting and texturing the strip configuration. The methodology as described in this patent, further includes a step of continuously unwinding this meat strip in a dehydrating solution bath, and subsequently curing the drawn-out minced meat strip at the output of the bath. This same methodology also includes a step for conveying the thin rolled mincemeat strip to a cutting and packaging station.

Further, U.S. Pat. No. 3,995,982 relates to a molding apparatus, and more specifically to a molding apparatus for forming articles and especially edible patties from moldable materials such as ground meat, fish and the like. The apparatus in this patent is described as including a moveable mold having a shaping portion formed therein, and a pressure means, including a pressure charger for applying pressure to the material therein, and for forcing the compressed material into the mold; and a pressure operated seal means communicating with the pressurized material for providing pressure operated seals, and substantially preventing the escape of pressurized material from the pressure cavities of the apparatus.

Additionally, other technology has been used for preparing meat strips for use in the preparation of foods such as jerky and the like. For example, one product as seen in the enclosed Information Disclosure Statement includes a substantially vertically oriented cylinder for receiving a ground meat product to be formed, and wherein the ground meat product is forced by means of a piston which is moveable within the cylinder, thereby causing the meat product to escape through a small aperture formed in the bottom of the cylinder. The ground meat product moving through the aforementioned small aperture moves through an extruding head, and which has formed therein a narrow rectangular opening. Mounted adjacent to the extruding head is a roll of release paper which is employed to catch the extruded, now rectangular shaped meat product, coming out from the extrusion head. The paper is advanced, by hand, to carry the extruded meat product down a sloping ramp which is located near the extrusion head. Thereafter, the release paper is separated from the meat product, and the meat product is processed in a smoker or other selected cooking appliance(s) to produce a resulting cooked ground meat food product.

While all these devices have operated with varying degrees of success, there have been numerous shortcomings attendant with their several physical features, and overall operational design which have detracted from them being widely embraced by consumers or used widely in the industry. For example, the previous prior art patents, discussed above, are unduly complex in their overall design. This complexity leads to obvious problems relating to keeping these devices clean and operational, especially when ground meat products having high fat content are utilized with same, and could be deposited within the devices, and which could be difficult to remove using normal cleaning techniques. Additionally, the prior art process, discussed above, requires some simultaneous physical coordination inasmuch as the operator must simultaneously apply mechanical pressure to extrude the ground meat while simultaneously withdrawing, by hand, the release paper which is receiving the extruded meat product as it comes out of the extrusion head. This previously described prior art device, noted in the paragraph immediately, above, also suffers from another shortcoming inasmuch as the extrusion of the ground meat product from the extrusion head may be uneven. This may result in a resulting extruded food product which has a variable thickness dimension. This non-uniform thickness dimension may also be caused by varying the speed with which the paper is drawn away from the extruding head. Therefore, the quality of the resulting product varies. Additionally, and with regard to the prior art patents, noted above, these devices are also quite costly to manufacture, and maintain, and are typically outside the economic reach of most consumers. It also should be understood that many consumers, such as sportsmen and the like, harvest meat such as venison, and the like, from wild game that they've lawfully taken during prescribed hunting seasons. These same sportsmen would like a convenient means whereby this harvested meat may be easily and rapidly converted into a given ground meat product which has uniform characteristics, and which results in a cooked, ground meat product which can be enjoyed at any time.

The methodology and resulting kit, as described, below, and which addresses the shortcomings attendant with the prior art devices and practices utilized, heretofore, is the subject matter of the present invention.

### SUMMARY OF THE INVENTION

A first aspect of the present invention relates to a method for preparing a ground meat product which includes the steps of providing a prepared, uncooked ground meat product; providing a food product forming container which has a bottom surface, with a peripheral edge, and wherein an elevated sidewall having a given height dimension is mounted about the peripheral edge of the bottom surface and which further has a top edge, and wherein the food product forming container further defines an internal cavity; depositing the prepared, uncooked ground meat product in the internal cavity which is defined by the food product forming container; providing a rolling pin; engaging the rolling pin with the top edge of the elevated sidewall and rolling the rolling pin along the top edge so as to forcibly engage the prepared, uncooked ground meat product and form a resulting prepared, uncooked ground meat layer which is densely packed, and which has a height dimension which is not greater than a height dimension of the elevated sidewall; and removing the resulting prepared, uncooked ground meat layer from the internal cavity; and cooking, curing, and/or drying the prepared, uncooked, ground meat layer in a cooking appliance.

Another aspect of the present invention relates to a method for preparing a ground meat food product which includes the steps of grinding an uncooked meat product to produce an uncooked ground meat product; combining a source of predetermined food ingredients with the uncooked ground meat product to form a prepared, uncooked ground meat product which is seasoned and/or cured; providing a food product forming container which has a bottom surface and a circumscribing peripheral sidewall which has a top edge, and wherein the food product forming container defines an internal cavity; covering the food product forming container with a metal cooking foil, and pressing the metal cooking foil into the internal cavity of the food product forming container so as to conformably cover the internal cavity of the food product forming container; depositing a given amount of prepared, uncooked, ground meat product into the internal cavity, and on top of the metal cooking foil so as to completely fill the internal cavity of the food product forming container; covering the food product forming container and the prepared, uncooked ground meat product deposited in the internal cavity thereof, with a food grade paper having a release coated surface; engaging the top edge of the food product forming container with a rolling pin, and rolling the rolling pin along the top edge so as to forcibly engage the food grade paper and the prepared, uncooked ground meat product underneath the food grade paper so as to form a resulting, prepared, uncooked ground meat layer which is densely compacted, and which further has a predetermined height dimension which is not greater than a height dimension of the peripheral sidewall of the food product forming container; removing the food grade paper from the food product forming container; scraping the excess uncooked ground meat from the top edge of the food product forming container, and from the metal cooking foil for reuse; lifting the metal cooking foil bearing the prepared uncooked ground meat layer having a predetermined height dimension from the internal cavity, and placing the metal cooking foil bearing the prepared, uncooked meat layer in a cooking appliance; first, heating the metal cooking foil bearing the prepared, uncooked ground meat to form a resulting partially cooked ground meat product, and wherein the step of first heating causes the uncooked, prepared ground meat to solidify on the metal cooking foil; removing the metal cooking foil bearing the partially cooked ground meat product from the cooking appliance; removing the metal foil from the partially cooked ground meat product; second, heating the partially cooked ground meat product at a second predetermined temperature and time; removing the partially cooked ground meat product from the cooking appliance; slicing the partially cooked ground meat product into predetermined sizes; and third heating the sliced, partially cooked ground meat product at a third predetermined temperature and time to produce a cooked ground meat product.

Yet a further aspect of the present invention relates to a kit for preparing a cooked, smoked, cured or dehydrated ground meat product which includes, a food product forming a container which has a bottom surface having a peripheral edge and wherein a circumscribing sidewall of substantially uniform height extends upwardly from the peripheral edge, and which has a top surface, and wherein the food product forming container defines an internal cavity, and wherein the food product forming container further has a length dimension of approximately less than about 22 inches and a width dimension of approximately less than about 14 inches; and a printed instruction sheet describing how to utilize the food product forming container to form a cooked ground meat product.

These and other aspects of the present invention will be discussed in greater detail hereinafter.

### BRIEF DESCRIPTION OF THE DRAWINGS

Preferred embodiments of the invention are described below with reference to the following accompanying drawings:

FIG. 1 is a perspective, side elevation view of a first step in the methodology of the present invention.

FIG. 2 is a depiction of a second step in the methodology of the present invention.

FIG. 3 is a depiction of the third step in the methodology of the present invention.

FIG. 4 is a depiction of the fourth step in the methodology of the present invention.

FIG. 5 is a depiction of the fifth step in the methodology of the present invention.

FIG. 6 is a depiction of the sixth step in the methodology of the present invention.

FIG. 7 is a depiction of the seventh step in the methodology of the present invention.

FIG. 8 is a depiction of the eighth step in the methodology of the present invention.

FIG. 9 is a depiction of the ninth step in the methodology of the present invention.

FIG. 10 is a depiction of the tenth step in the methodology of the present invention.

FIG. 11 is a depiction of the eleventh step in the methodology of the present invention.

FIG. 12 is a depiction of the twelfth step in the methodology of the present invention.

FIG. 13 is a depiction of the thirteenth and fourteenth steps in the methodology of the present invention.

FIG. 14 is a depiction of the fifteenth step in the methodology of the present invention.

FIG. 15 is a depiction of the sixteenth and seventeenth steps in the methodology of the present invention.

FIG. 16 is a depiction of the eighteenth and nineteenth steps in the methodology of the present invention.

FIG. 17 is a depiction of the twentieth step in the methodology of the present invention.

FIG. 18 is a depiction of the kit which forms a feature of the present invention.

### DETAILED DESCRIPTION OF THE PREFERRED EMBODIMENTS

This disclosure of the invention is submitted in furtherance of the constitutional purposes of the U.S. Patent laws “to promote the progress of science and the useful arts” [Article I, Section 8].

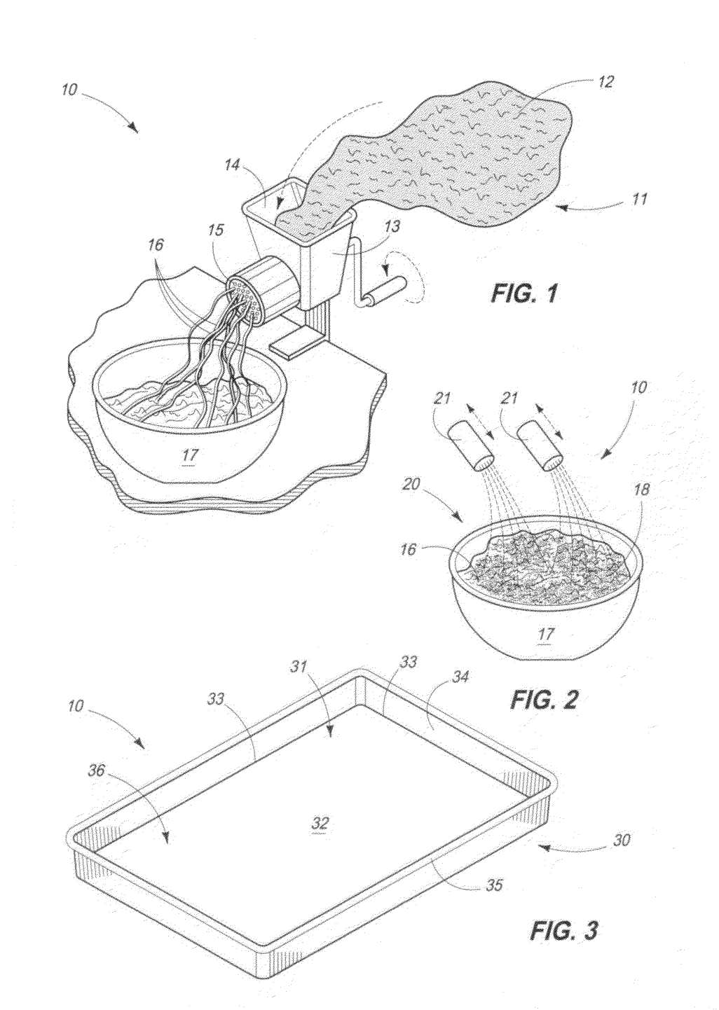

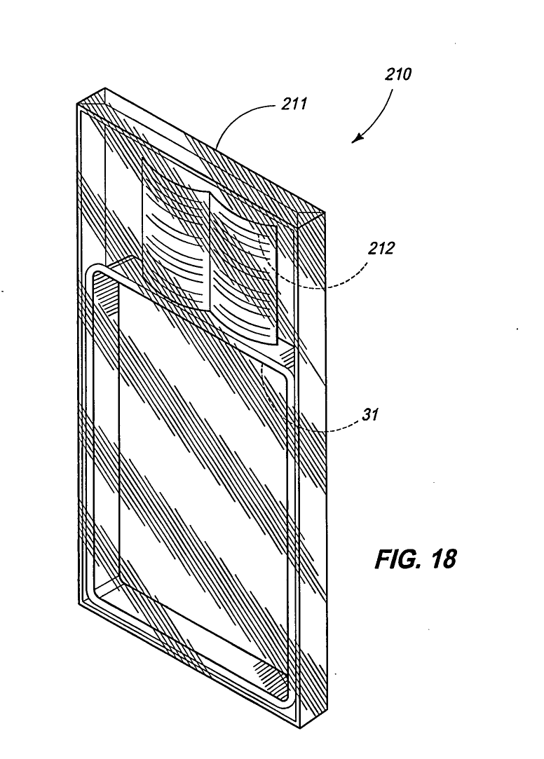

A method for preparing a ground meat product of the present invention is generally indicated in the steps identified in FIGS. 1 through 17, respectively. The kit which forms a feature of the present invention is seen in FIG. 18. With respect to the method for preparing a ground meat product of the present invention, the first step 11 which is shown in FIG. 1 includes providing a source of an uncooked meat product which is generally indicated by the numeral 12. The source of the uncooked meat product 12 may comprise a domestically produced ground meat product or products, of various types. It may also include uncooked meat products which have been previously harvested from wild animals that have been lawfully taken by a hunter or the like. The source of uncooked meat product 12 is provided to a meat grinder 13 of conventional design. The meat grinder 13 has an input end 14 for receiving the source of uncooked meat product, and an output end 15 which provides a discharge opening for the resulting ground, uncooked meat product 16 which has now been prepared to a given minced or grounded consistency. The uncooked, ground meat product 16 is received in a collection container or mixing bowl of traditional design 17.

Referring now to FIG. 2, a second step of the present invention is generally indicated by the numeral 20. As seen therein, the mixing container 17 is provided, and this step includes combining a source of the predetermined food ingredients, here indicated by the numeral 21, to form a prepared, uncooked ground meat product which is seasoned and/or cured to the desired amount by a user (not shown). The respective containers 21 as shown in FIG. 2 may provide either condiments, seasonings or other food product ingredients which are then mixed with the uncooked ground meat product 16 to provide the resulting prepared, uncooked ground meat product 18 which is then ready for further processing.

The methodology 10 of the present invention includes a third step which is generally indicated by the numeral 30, and which includes providing a food forming container 31, which has a bottom surface 32, having a peripheral edge 33. Elevated side walls 34 having a given height dimension are mounted about the peripheral edge 33 of the bottom surface. Further, the peripheral or elevated sidewall 34 has a top edge 35. The continuous elevated sidewall 34, in combination with the bottom surface 32, defines an internal cavity 36 which will receive the prepared uncooked ground meat product 18 following the further steps as will be described, hereinafter. In the arrangement as seen in the drawings, the food product forming container 31, and more specifically the internal cavity thereof, typically has internal dimensions of about 12″ wide by about 18″ long by about one-quarter inch deep. Still further, the elevated sidewall 34 typically has a height dimension of less than about one-half inch and the top edge 35 has a width dimension of less than about one to about two inches. Additionally, the bottom surface has a thickness dimension of less than about one-quarter to about one-half inches on average. The food product forming container can be fabricated from various rigid substrates including wood, metal and/or plastic or assorted other moldable, synthetic material, and the like. It will be recognized that the elevated sidewalls may be of various heights which range from as little as one-eighth of an inch, to 2 inches in height depending upon the resulting food product which is desired.

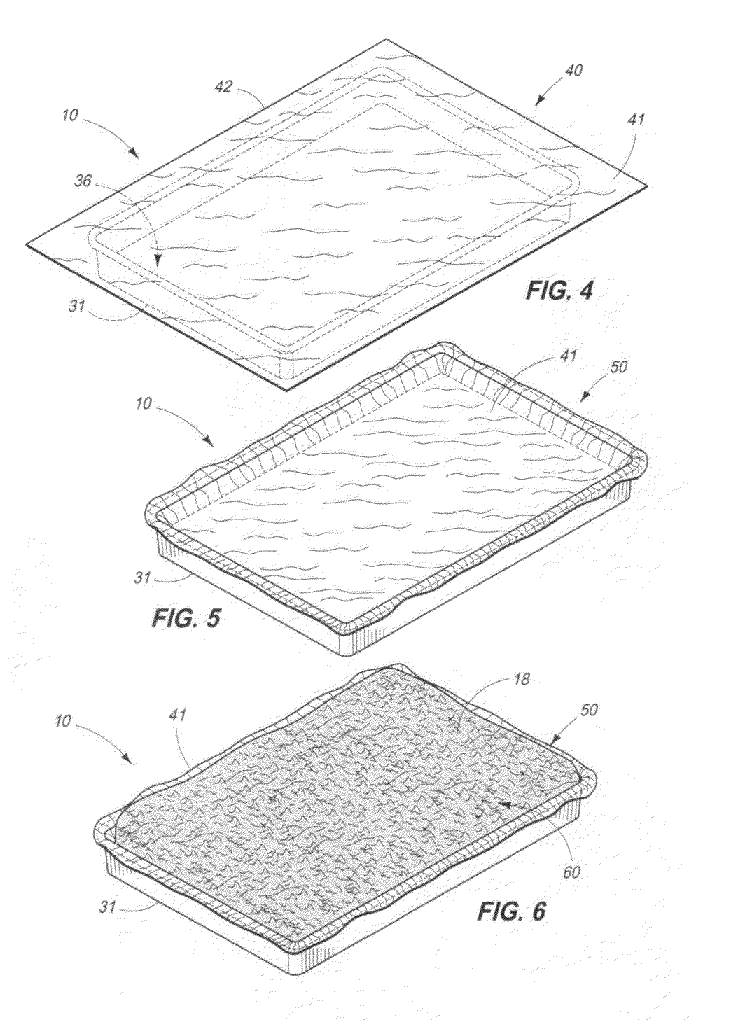

The methodology of the present invention includes a fourth step which is generally indicated by the numeral 40 (FIG. 4). The fourth step 40 includes providing a metal cooking foil 41 having dimensions greater than the length and width dimensions of the food product forming container 31. After providing the metal cooking foil 41, which is supplied in an appropriate size, the cooking foil 41 is placed in covering relation 42 over the food product forming container 31. In a fifth step which is generally indicated by the numeral 50, and as seen in FIG. 5, this step includes pressing in, or conformably mating or forcibly molding the metal cooking foil 41 to closely fit the shape of the internal cavity 36 of the food product forming container 31.

The sixth step, 60, of the methodology of the present invention includes depositing a given amount of the prepared, uncooked ground meat product 18 into the internal cavity 36, and on top of the metal cooking foil 41 so as to completely fill the internal cavity 36 of the food product forming container 31. This is best illustrated by reference to FIG. 6. As will be appreciated, the prepared, uncooked ground meat product 18, and more specifically the top surface thereof extends typically slightly above the top edge 35 of the food product forming container 31 once this deposit, in the sixth step, 60, has been made.

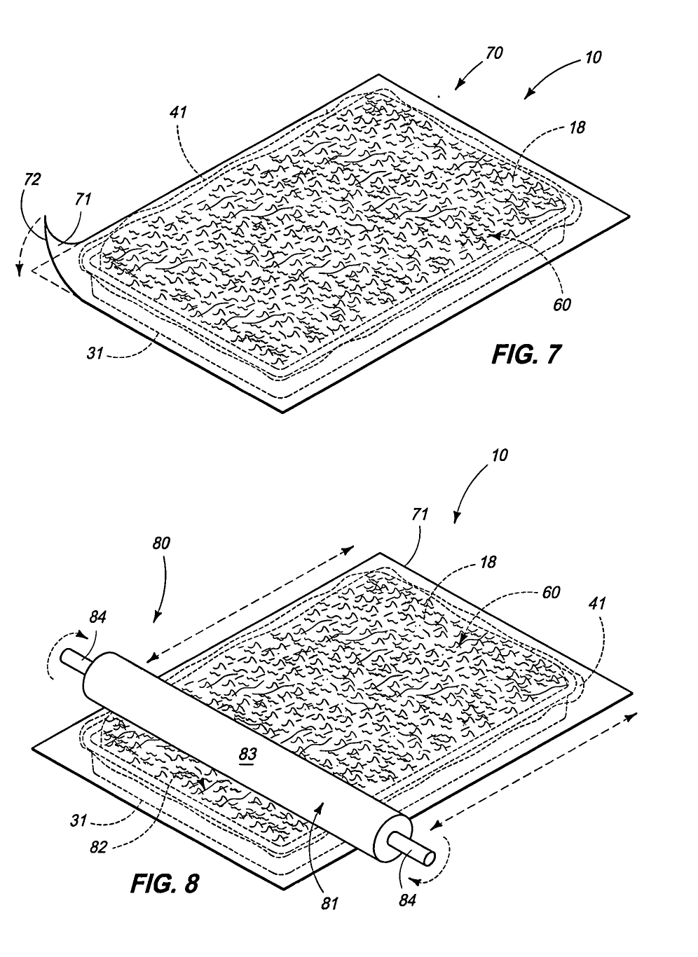

A seventh step of the present invention 10 is generally indicated by the numeral 70, and is best seen by reference to FIG. 7. As seen therein, the seventh step 70 includes covering the food product forming container 31, and the prepared, uncooked, ground meat product 18 deposited in the internal cavity 36 thereof, with a food grade paper 71, and which has a release coated surface that is generally indicated by the numeral 72. As will be appreciated from a study of FIG. 7, the food grade paper 71 may include such papers as wax paper and the like, and which are commercially available from various retail sources. Still further, the size of the food grade paper 71 is typically larger than the surface area of the bottom surface 32 of the food product forming container 31, and rests on the top edge of the elevated side walls 35.

The eighth step of the methodology 10 of the present invention is generally indicated by the numeral 80 and is best seen in FIG. 8. This step includes engaging the top edge 35 of the food product forming container 31 with a rolling pin 81, and rolling or moving the rolling pin 81 along the top edge 35 so as to forcibly engage the food grade paper 71, and the underlying prepared, uncooked ground meat product 18, so as to form or produce a resulting prepared, uncooked, densely compacted ground meat layer 82, and which further has a predetermined height dimension which is not greater than the height dimension of the peripheral sidewall 34 of the food product forming container 31. The rolling pin 81, as illustrated, has a length dimension which is greater than the width dimension of the food product forming container 31. Still further, the rolling pin 81, has a central rolling engaging portion 83, which is long enough to span over the width dimension of the product forming container 31, and further is operable to forcibly engage the top edge 35 of the peripheral or elevated sidewall 34. The rolling pin has opposite operating handles 84 which are engaged, or held by, an operator, not shown, in order provide the physical force required to produce the prepared, uncooked densely compacted ground meat layer 82 within the internal cavity 36 of the food product forming container 30.

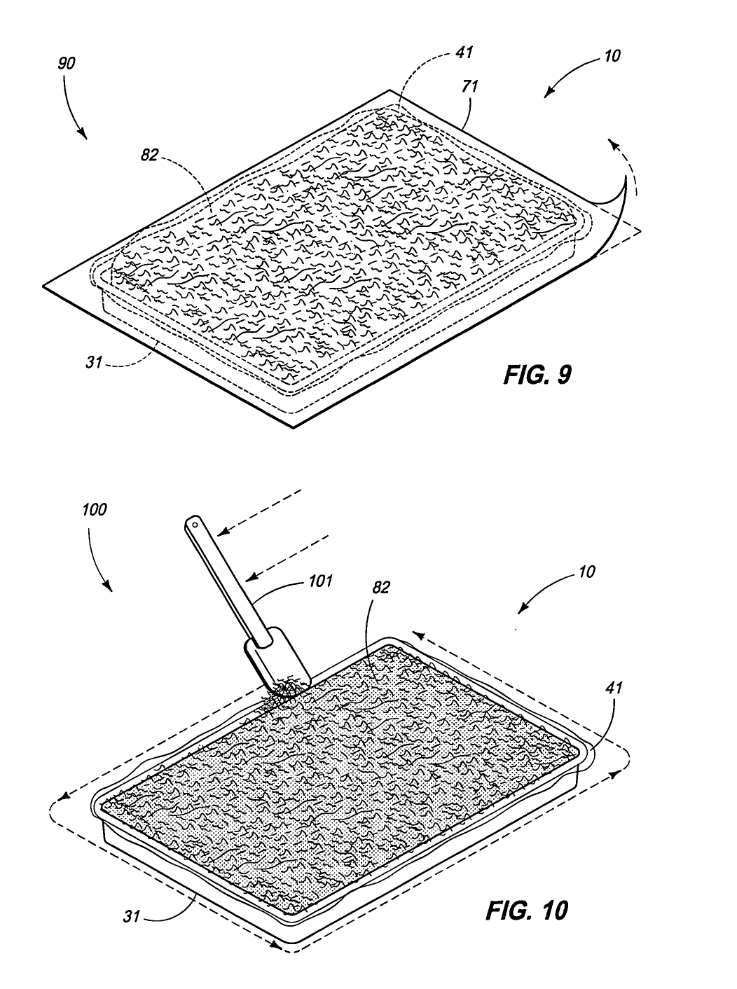

The ninth step, 90, of the methodology of the present invention 10, and as seen in FIG. 9, includes removing the food grade paper 71. The release coating 72 allows the food grade paper to be easily released from the food product forming container 31, and the underlying prepared, uncooked densely compacted ground meat layer 82. Occasionally, during this step a small portion or region of the prepared uncooked, densely compacted ground meat layer 82 may have a depression or cavity in the top surface thereof. If this event occurs a user (not shown) would add ground meat from the food product mixing container 17, or scrape the ground meat adhering to the food grade paper 71, or the metal cooking foil 41, and then return it to the area or region of the top surface of the uncooked, densely compacted ground meat layer 82 that has a depression or cavity by utilizing a cooking utensil such as spatula or the like, 101, as described, below. As will be appreciated, the eighth step of the methodology 80 (FIG. 8) has the effect of causing the uncooked ground meat product 18 which is deposited in the internal cavity 36 to be squeezed, at least in part, onto the top edge 35 of the food product forming container 31 during the execution of step 8. Following Step 9, 90, that being the removal of the food grade paper 71 from the covering position over the food product forming container 31, the methodology of the present invention includes a tenth step 100 (FIG. 10) which includes scraping the any excess uncooked ground meat which has become deposited on the top edge 35 of the food product forming container 31 and/or which adheres to the metal cooking foil 41 or the food grade paper 71 for reuse. To execute this step, a spatula 101 is typically provided, and is illustrated in FIG. 10 as being utilized to clear the top edge 35 of the food product forming container 31.

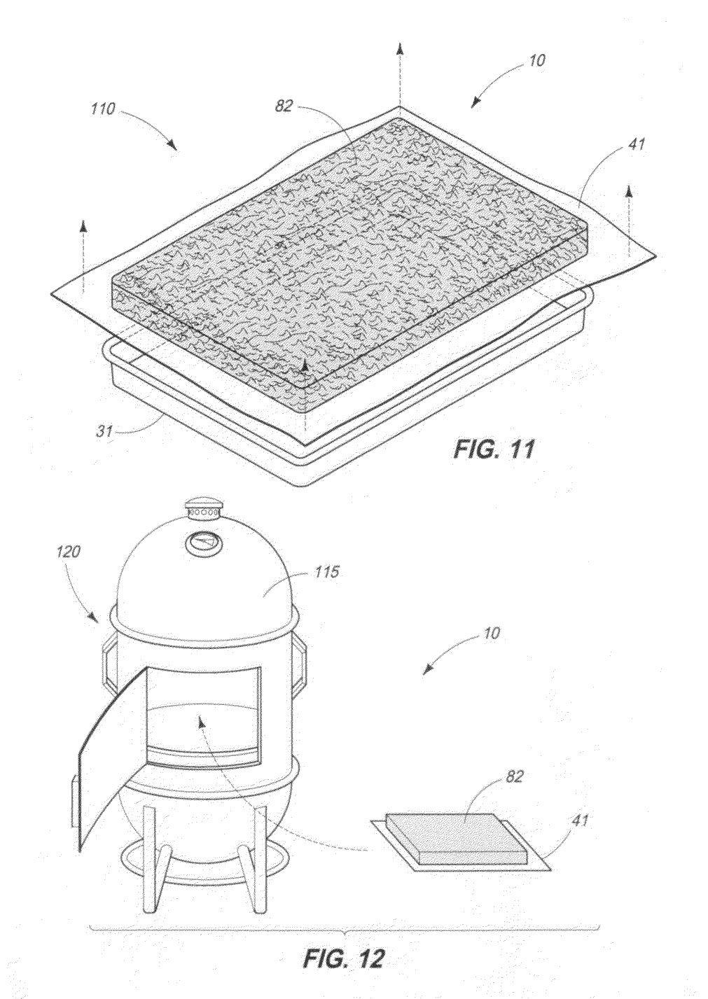

The eleventh step of the present invention is generally indicated by the numeral 110, and is seen in FIG. 11. The eleventh step 110 includes lifting the metal cooking foil 41 bearing the prepared, uncooked, compacted, ground meat layer 82 having a predetermined height dimension from the internal cavity 36, and then placing the metal cooking foil 41, bearing the prepared uncooked, densely compacted meat layer 82, into a cooking appliance 115. The placement of the prepared uncooked meat layer into the cooking appliance 115 comprises the twelfth step 120 of the present methodology and which is seen in FIG. 12. In connection with placing the prepared, uncooked compacted meat layer 82 into the cooking appliance 115, it will be appreciated that the cooking appliance 115, as depicted, may comprise an oven, smoker, dehydrator and/or barbecue. Once placed in the cooking appliance, the prepared, uncooked, densely compacted meat layer 82 is cooked for a first temperature and time, which is variable, and which is typically about two hours at a temperature of about 150° to 200° F. While a single type of cooking appliance 115 is shown, it will be appreciated that several different cooking appliances may be used in a serial fashion during the first, or later described cooking or heating steps. For example, a smoker and oven, or dehydrator and smoker, could be used in combination, or separately to achieve the first or later described steps of cooking of heating the prepared densely compacted ground meat layer 82. Therefore, it will be appreciated by studying FIG. 12 that the appliance 115, as illustrated, is a smoker, but this smoker is only generally representative of any number of different types of possible cooking or heating appliances 115 that may be utilized in connection with implementing the methodology of the present invention. As will be seen in FIG. 12, the prepared, uncooked and densely compacted ground meat layer 82 is carried and placed within the cooking appliance 115 by means of the metal cooking foil 41 which supports same, and then the cooking or heating appliance 115 applies the predetermined heat, noted above, for the given time period as recited, above.

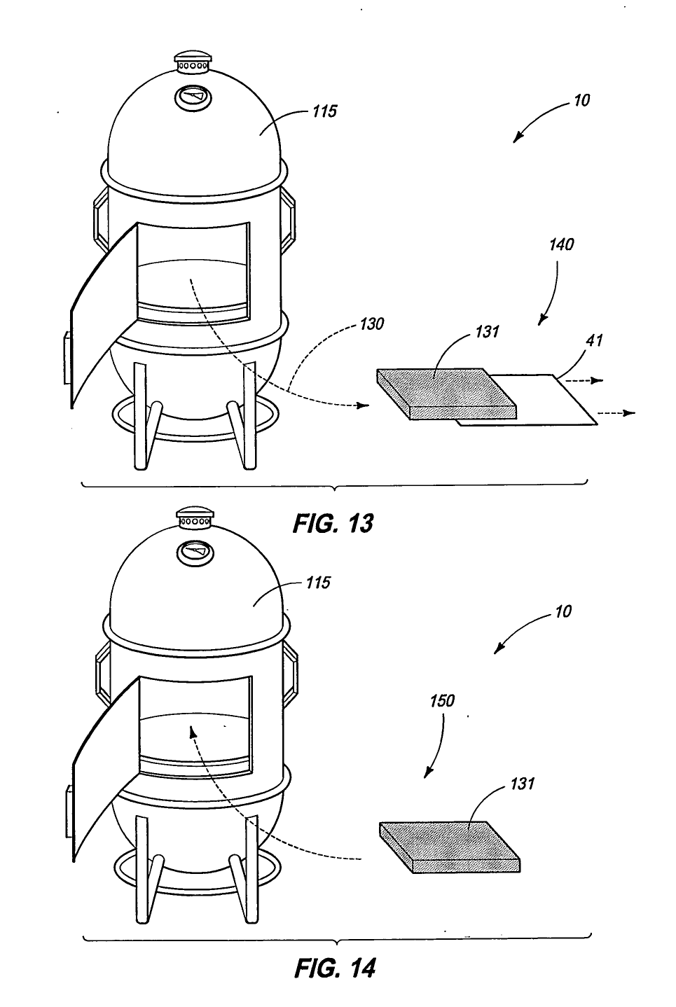

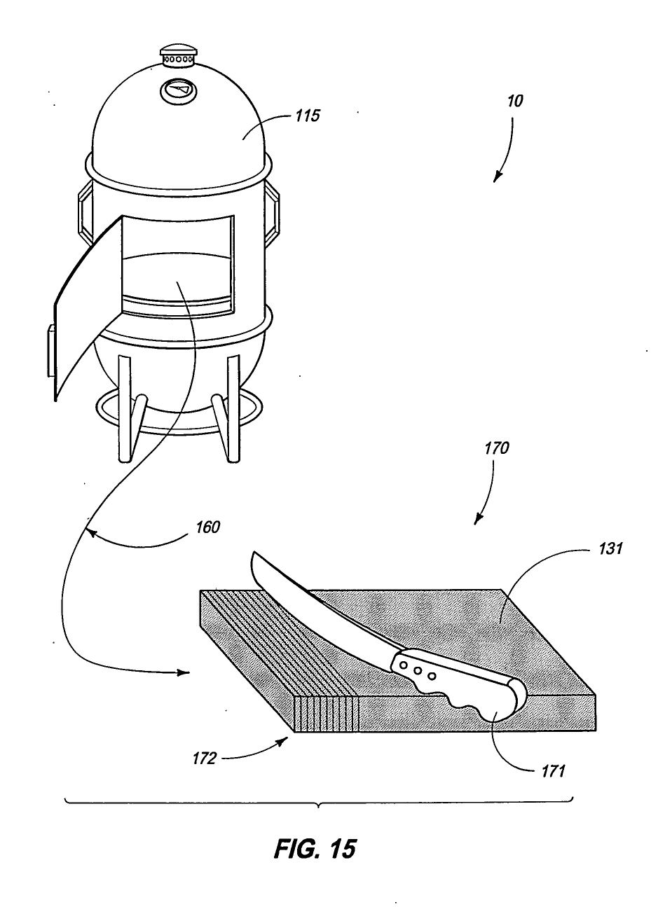

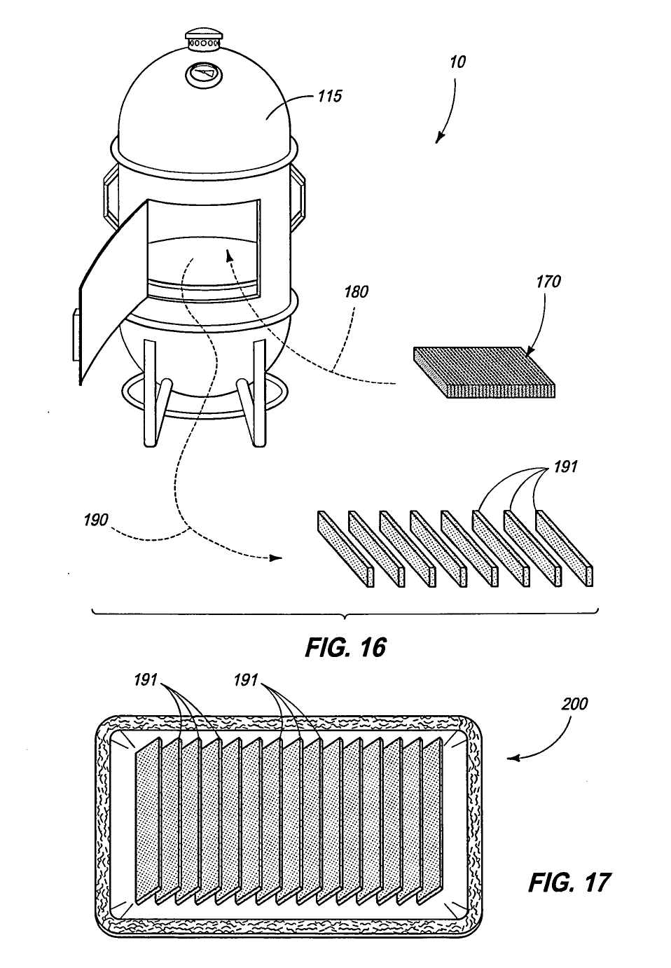

The thirteenth step of the methodology of the present invention 10 is generally indicated by the numeral 130, and is best seen in FIG. 13. This step of the methodology 10 includes removing or carrying the metal cooking foil 41 which now bears a partially cooked ground meat product 131 from the cooking appliance 115. The methodology 10 also includes a fourteenth step which is generally indicated by the numeral 140 (also seen in FIG. 13), and which includes removing or stripping away the metal cooking foil 41 from the partially cooked ground meat product 131. The fifteenth step 150 of the methodology of the present invention is best seen by reference to FIG. 14, and further includes a second, heating of the partially cooked ground meat product 131 at a second predetermined temperature and time. This second predetermined temperature, and time, is about two hours at about 150° to about 200° F. Once Step 15, 150, of the present invention is accomplished, Step 16, 160, as best seen in FIG. 15, is undertaken. Step 16, 160, includes removing the partially cooked ground meat product 131, from the cooking appliance 115. Step, 17, 170, of the present invention and which is seen in FIG. 15 further comprises slicing the partially cooked ground meat product 131 into predetermined sizes 172. The step of slicing 170 the partially cook ground meat product 131 into predetermined sizes 172 may be accomplished by using a traditional means such as by employing a knife 171, as shown in the drawing. The thickness of the partially cooked ground meat product is determined by the user based upon the type of ground meat product being prepared. The eighteenth step of the present invention, 180, (FIG. 16), includes a third, heating of the sliced, partially cooked, sliced, ground meat product 172 at a third predetermined temperature, and time, to produce a cooked ground meat product 191. The third predetermined temperature and time is about one hour, at about 150° to about 200° F. in the cooking appliance 115. Following the eighteenth step 180 of the third heating of the sliced partially cooked ground meat product, the now cooked ground meat product 191 is removed from the cooking appliance 115 at the nineteenth step 190, as seen in FIG. 16. The cooked ground meat product 191, thereafter, is packaged, in a twentieth step which is generally indicated by the numeral 200 (FIG. 17). The packaging provides a means whereby convenient, predetermined amounts of the cooked ground meat product 191 can be made readily available for a consumer's use at any time following packaging.

As best seen in FIG. 18, the present invention includes, as one of its features, a kit for preparing a cooked ground meat product, and which is generally indicated by the numeral 210. The kit 210 includes packaging 211 which encloses the food product forming container 31, and a printed instruction sheet 212 which discloses the aforementioned 20 steps described, above. This kit 210, in another variation, may include, for example, the rolling pin 81, and/or the spatula 101. Additionally, the kit 210 may include various condiments or seasonings 21, or other recipes that a user may employ to make any number of desirable cooked ground meat products 121.

### Operation

The operation of the described methodology of the present invention is believed to be readily apparent, and is briefly summarized at this point. The present methodology 10 for preparing a ground meat product includes the steps of providing a prepared, uncooked, ground meat product 12; providing a food product forming container 31 which has a bottom surface 32, with a peripheral edge 33, and wherein an elevated sidewall 34 having a given height dimension is mounted about the peripheral edge 33 of the bottom surface 32 and which further has a top edge 35, and wherein the food product forming container 31 further defines an internal cavity 36. The method further includes a step of depositing the prepared, uncooked, ground meat product in a step, 60, in the internal cavity 36 of the food product forming container 31. The method 10 also includes the step 80 of providing a rolling pin 81, and engaging the rolling pin 81 with the top edge 35, of the elevated sidewall 34, and forcibly rolling the rolling pin 81 along the top edge 35 so as to forcibly engage the prepared, uncooked ground meat product 18 and form a resulting prepared, uncooked, densely compacted ground meat layer 82, and which further has a height dimension which is not greater than the height dimension of the elevated sidewall 34. The method further includes the step 110 of removing the resulting prepared uncooked and densely compacted ground meat layer 82, from the internal cavity 36; and cooking 120 the prepared, uncooked ground meat layer 82 in a cooking appliance 115.

The present invention 10 also relates to a kit 210 for preparing a cooked, smoked, cured or dehydrated ground meat product 16 which includes a food product forming container 31 which has a bottom surface 32, having a peripheral edge 33, and wherein a circumscribing sidewall 34 of substantially uniform height extends upwardly from the peripheral edge and which has a top surface 35. The food product forming container 31 defines an internal cavity 36. The food product forming container 31 further has a length dimension of less than about 22 inches, and a width dimension of approximately less than about 14 inches. The kit 210 for preparing a cooked, smoked, cured or dehydrated ground meat product further includes a printed instruction sheet 212 describing how to utilize the food product forming container 31 to manufacture a cooked, ground meat product 191. The kit 210 is seen in FIG. 18. The printed instruction sheet 212 describes a method of preparing a cooked, smoked, cured or dehydrated ground meat product which comprises a step 11 of grinding an uncooked meat product 12 to produce an uncooked ground meat product, 16. The method includes another step 20 of combining a source of predetermined food ingredients 21 with the uncooked or ground meat product 16 to form a prepared, grounded meat product 18 as seen in FIG. 2. The method includes another step 40 of placing the food product forming container 31 on an underlying supporting surface, and covering the food product forming container with a metal cooking foil 41 as seen in FIG. 4 and pressing the metal cooking foil 41 into the internal cavity 36 of the food product forming container 31 so as to conformably cover the internal cavity 36 of the food product forming container 31. This is best seen in FIG. 5. The printed instruction sheet 212 further describes the step 60 of depositing a given amount of prepared, uncooked ground meat product 18 into the internal cavity 36 of the food product forming container 31 and on top of the metal cooking foil 41 so as to completely fill the internal cavity 36 of the food product forming container 31. The methodology described in the printed instruction sheet 212 further describes the step 70 of covering the food covering forming container 31, and the prepared, uncooked ground meat product deposited in the internal cavity 36, with the food grade paper 71 having a release coated surface 72. This is best seen in FIG. 7. The instruction sheet 212 further describes the step 80 of engaging the top edge 35 of the food product forming container 31 with a rolling pin 81, and rolling it along the top edge 35 so as to forcibly engage the food grade paper 71, and the prepared, uncooked ground meat product 18 underneath the food grade paper 71 so as to form a resulting, prepared, uncooked, densely compacted ground meat layer 82, having a predetermined height dimension which is not greater than the height dimension of the peripheral sidewall 34 of the food product forming container 31. The printed instruction sheet 212 further describes a step 90 of removing the food grade paper 71 from the food product forming container 31 and scraping 100 any excess, uncooked, ground meat product from the top surface 35 of the peripheral side wall 34 of the food product forming container 31. The methodology as described includes a further step 110 of lifting the metal cooking foil 41 bearing the prepared, uncooked, densely compacted ground meat layer 82, having a predetermined height dimension 110 (FIG. 11) from the internal cavity 36, and placing the metal cooking foil 41 bearing the prepared, uncooked meat layer 82, in a cooking appliance 115 at the step labeled 120 and first heating the metal cooking foil bearing the prepared, uncooked and densely compacted ground meat layer 82 in the cooking appliance 115 as seen in FIG. 12. Further, the printed instruction sheet 212 describes two other steps which are generally indicated by the numerals 130, and 140 respectively, (FIG. 13), and wherein the partially cooked ground meat product 131 is first removed, 130, from the cooking device 115, and the metal cooking foil 41 is removed, 140, from the partially cooked ground meat layer 131. The instruction sheet 212 then describes another step, 150, after removing 140 the metal cooking foil 41 from the partially cooked ground meat product, 131, which includes a second heating 150 of the partially cooked ground meat product 131 at a second predetermined time and temperature (FIG. 14). The methodology as described further includes a step 170 of slicing the partially cooked ground meat product 131 into predetermined sizes, 172, as seen in FIG. 15; and thirdly, heating 180 the sliced partially cooked ground meat product 172 at a third predetermined time and temperature to produce a cooked, smoked, cured and dried ground meat product 191. In step 190 the cooked ground meat product 191 is removed from the cooking device 115 (FIG. 16). The cooked ground meat product 191 is then subsequently packaged at step 200 as seen in FIG. 17.

Therefore, it will be seen that the methodology of the present invention 10 provides a very convenient means by which an individual can conveniently and economically prepare a desirable cooked ground meat product in a manner not possible heretofore. The present methodology provides a convenient means whereby such products can be economically produced without the need of complex machinery and further provides a resulting cooked, ground product 181 which is uniform in dimensions and which when cooked in an appropriate manner provides a resulting food product which can be eaten and enjoyed at any given time by a consumer.

I claim:

1. A method for preparing a ground meat product, comprising:
providing a prepared, uncooked, ground meat product;
providing a food product forming container which has a bottom surface, with a peripheral edge, and wherein an elevated sidewall having a given height dimension is mounted about the peripheral edge of the bottom surface, and which further has a top edge, and wherein the food product forming container further defines an internal cavity;
depositing the prepared, uncooked, ground meat product in the internal cavity which is defined by the food product forming container;
providing a rolling pin;
engaging the rolling pin with the top edge of the elevated sidewall, and rolling the rolling pin along the top edge so as to forcibly engage the prepared, uncooked ground meat product and form a resulting prepared, uncooked, ground meat layer which is densely packed, and which has a height dimension which is not greater than a height dimension of the elevated sidewall; and
removing the resulting prepared, uncooked, ground meat layer from the internal cavity, and cooking the prepared, uncooked ground meat layer in a cooking appliance.

2. A method as claimed in claim 1, and further comprising:
providing a mixing container and depositing and mixing an uncooked meat product with predetermined food ingredients in the mixing container to form the prepared, uncooked, ground meat product.

3. A method as claimed in claim 1, and further comprising:
after the step of providing the food product forming container, and before the step of depositing the prepared, uncooked, ground meat product in the internal cavity, providing a first flexible substrate and placing the first flexible substrate in covering relation over the food product forming container.

4. A method as claimed in claim 3, and further comprising:
after the step of depositing the prepared, uncooked ground meat product in the internal cavity, and before the step of providing a rolling pin, providing a second flexible substrate which is placed in covering relation over the food product forming container which contains the prepared, uncooked ground meat product, and wherein the step of engaging the rolling pin with the top edge of the elevated sidewall comprises employing the rolling pin to compact the prepared, uncooked, ground meat product between the first and second flexible substrates into a dense layer within the internal cavity of the food product forming container.

5. A method as claimed in claim 4, and wherein after the step of engaging the top edge of elevated sidewall with the rolling pin, the method further comprises:
removing the second flexible substrate from the resulting prepared, uncooked ground meat layer, and wherein the step of removing the resulting prepared, uncooked ground meat layer from the internal cavity further comprises applying a lifting force to the first flexible substrate so as to remove the first flexible substrate and the resulting prepared, uncooked ground meat layer from the internal cavity, and placing the first flexible substrate bearing the resulting prepared, uncooked ground meat layer in the cooking appliance.

6. A method as claimed in claim 1, and wherein, after the step of depositing the prepared, uncooked ground meat product in the internal cavity of the food product forming container, the method further comprises distributing the prepared uncooked ground meat product so as to cover the entire bottom surface and substantially fill the internal cavity of the food product forming container, and wherein the step of cooking the resulting prepared, uncooked ground meat product includes smoking; drying; curing or barbecuing the prepared uncooked ground meat product by employing an oven; smoker; dehydrator; and/or barbecue.

7. A method as claimed in claim 5, and wherein the step of cooking the resulting prepared, uncooked, ground meat layer further comprises, first, placing the resulting prepared, uncooked, ground meat layer which is supported on the first substrate in a cooking appliance comprising an oven, smoker, dehydrator, and/or barbecue for a first predetermined period of time and first temperature so as to form a resulting partially cooked ground meat layer; secondly, removing the resulting partially cooked ground meat layer and the underlying first substrate from the cooking appliance; thirdly, removing the first substrate from the resulting partially cooked ground meat layer; fourthly, placing the resulting, partially cooked ground meat layer back into the cooking appliance for a given, second time period, and a second temperature; fifthly removing the partially cooked ground meat layer and slicing the partially cooked ground meat layer into predetermined sizes; and sixthly placing the resulting, partially cooked, sliced, ground meat layer back into the cooking appliance for a given, third time period, and third temperature to produce a cooked, ground meat product.

8. A method as claimed in claim 1, and wherein the elevated sidewalls of the food product forming container are less than about one-half inches in height.

9. A method as claimed in claim 1, and wherein the bottom surface of the food product forming container has a width dimension of approximately less than about 14 inches, and a length dimension of approximately less than about 22 inches.

10. A method as claimed in claim 9, and wherein the rolling pin has a central rolling engaging portion, and a pair of opposite operator handles, and wherein the central rolling engaging portion has a length dimension which is greater than the width dimension of the internal cavity of the food product forming container.

11. A method as claimed in claim 3, and wherein the first flexible substrate comprises a flexible metal cooking foil which is forcibly conformed to the internal cavity of the food product forming container.

12. A method as claimed in claim 4, and wherein the second flexible substrate comprises a food grade paper having a release coated surface.

13. A method as claimed in claim 7, and wherein the first predetermined time and first temperature of the given cooking appliance which is selected is variable and is about 2 hours at a temperature of about 150 to about 200 degrees F.; the second given time and second temperature is about two hours at about 150 to about 200 degrees F.; and the third given time and temperature is about one hour at about 150 to about 200 degrees F.

14. A method as claimed in claim 2 and further comprising:
scraping the top edge of the food product forming container to remove prepared, uncooked ground meat product which is deposited on the top edge of the food product forming container when the rolling pin forcibly rollingly engages the top edge of the food product forming container after the prepared uncooked meat product is densely packed within the internal cavity thereof; and
returning the prepared uncooked food ground meat product scraped from the top edge of the food product forming container to the mixing container for further use.

15. A method for preparing a ground meat food product, comprising:
grinding an uncooked meat product to produce an uncooked ground meat product;
combining a source of predetermined food ingredients with the uncooked ground meat product to form a prepared, uncooked ground meat product which is seasoned and/or cured;
providing a food product forming container which has a bottom surface, and a circumscribing peripheral side wall which has a top edge, and wherein the food product forming container defines an internal cavity;
covering the food product forming container with a metal cooking foil, and pressing the metal cooking foil into the internal cavity of the food product forming container so as to conformably cover the internal cavity of the food product forming container;
depositing a given amount of the prepared, uncooked, ground meat product into the internal cavity, and on top of the metal cooking foil, so as to completely fill the internal cavity of the food product forming container;
covering the food product forming container, and the prepared, uncooked ground meat product deposited in the internal cavity thereof with a food grade paper having a release coated surface;
engaging the top edge of the food product forming container with a rolling pin, and rolling the rolling pin along the top edge so as to forcibly engage the food grade paper and the prepared uncooked ground meat product underneath the food grade paper so as to form a resulting, prepared, uncooked ground meat layer which is densely compacted and which further has a predetermined height dimension which is not greater than a height dimension of the peripheral sidewall of the food product forming container;
removing the food grade paper from the food product forming container;
scraping the excess uncooked ground meat from the top edge of the food product forming container and from the metal cooking foil for reuse;
lifting the metal cooking foil bearing the prepared, uncooked ground meat layer having a predetermined height dimension from the internal cavity, and placing the metal cooking foil bearing the prepared, uncooked meat layer in a cooking appliance;
first, heating the metal cooking foil bearing the prepared, uncooked ground meat product with the cooking appliance at a first predetermined temperature and time to form a resulting partially cooked ground meat product;
removing the metal cooking foil bearing the partially cooked, ground meat product from the cooking appliance;
removing the metal cooking foil from the partially cooked ground meat product;
second, heating the partially cooked ground meat product at a second predetermined temperature and time;
removing the partially cooked ground meat product from the cooking appliance;
slicing the partially cooked ground meat product into predetermined sizes; and
third, heating the sliced, partially cooked ground meat product at a third predetermined temperature and time to produce a cooked ground meat product.

16. A method as claimed in claim 15, and wherein the cooking appliance comprises a smoker, and wherein the first predetermined time and temperature is about 2 hours at about 150 degrees to about 200 degrees F.; the second predetermined time and temperature is about 2 hours at about 150 degrees to about 200 degrees F.; and the third predetermined time and temperature is about 1 hour at about 150 degrees to about 200 degrees F.

17. A method as claimed in claim 16, and wherein the prepared, uncooked meat product which is removed from the internal cavity of the food product forming container has an approximate height dimension of less than about one-half inch; and wherein the food product forming container has length dimension of less than about 22 inches, and a width dimension of less than about 14 inches; and wherein the rolling pin has an overall length dimension greater than the width dimension of the food product forming container.

18. A kit for preparing a cooked, smoked, cured or dehydrated ground meat product, comprising:
a food product forming container which has bottom surface having a peripheral edge, and wherein a circumscribing sidewall of substantially uniform height extends upwardly from the peripheral edge and which has a top surface, and wherein the food product forming container defines an internal cavity, and wherein the food product forming container further has a length dimension of approximately less than about 22 inches, and a width dimension of approximately less than about 14 inches;
a printed instruction sheet describing how to utilize the food product forming container to form a cooked ground meat product.

19. A kit as claimed in claim 18, and further comprising:
a rolling pin having a length dimension which is greater than the width dimension of the food product forming container; and
a food scraper which is utilized to scrape an uncooked ground meat food product from the top surface of the circumscribing sidewall of the food product forming container.

20. A kit for preparing a cooked ground meat product, as claimed in claim 19, and wherein the printed instruction sheet describes a method of preparing a cooked, smoked, cured or dehydrated ground meat product which comprises:
grinding an uncooked meat product to produce an uncooked ground meat product;
combining a source of predetermined food ingredients with the uncooked ground meat product to form a prepared, uncooked ground meat product;
placing the food product forming container on an underlying supporting surface;
covering the food product forming container with a metal cooking foil, and pressing the metal cooking foil into the internal cavity of the food product forming container so as to conformably cover the internal cavity of the food product forming container;
depositing a given amount of the prepared, uncooked, ground meat product into the internal cavity of the food product forming container, and on top of the metal cooking foil, so as to completely fill the internal cavity of the food product forming container;
covering the food product forming container, and the prepared, uncooked ground meat product deposited in the internal cavity, thereof, with a food grade paper having a release coated surface;
engaging the top edge of the food product forming container with a rolling pin, and rolling the rolling pin along the top edge so as to forcibly engage the food grade paper and the prepared uncooked ground meat product underneath the food grade paper so as to form a resulting, prepared, uncooked and densely compacted ground meat layer having a predetermined height dimension which is not greater than a height dimension of the peripheral sidewall of the food product forming container;
removing the food grade paper from the food product forming container;
scraping any excess uncooked ground meat product from the top surface of the peripheral sidewall of the food product forming container;
lifting the metal cooking foil bearing the prepared, uncooked ground meat layer having a predetermined height dimension from the internal cavity, and placing the metal cooking foil bearing the prepared, uncooked meat layer in a cooking appliance;
first, heating the metal cooking foil bearing the prepared, uncooked ground meat product with a cooking appliance at a first predetermined temperature and time to form a resulting partially cooked ground meat product;
removing the metal cooking foil bearing the partially cooked, ground meat product from the cooking appliance;
removing the metal cooking foil from the partially cooked ground meat product;
second, heating the partially cooked ground meat product at a second predetermined temperature and time;
removing the partially cooked, ground meat product from the cooking appliance;
slicing the partially cooked ground meat product into predetermined sizes; and
third, heating the sliced, partially cooked ground meat product at a third predetermined temperature and time to produce a cooked, smoked, cured or dried ground meat product.
